(19) United States
(12) Patent Application Publication
(10) Pub. No.: US 2006/0227387 A1
(43) Pub. Date: Oct. 12, 2006

(54) Light-transmissive cylindrical platen

(75) Inventor: James W. Patterson, Newark, NY (US)

Correspondence Address: PILLSBURY WINTHROP SHAW PITTMAN, LLP, P.O. BOX 10500, MCLEAN, VA, 22102, US

(73) Assignee: Xerox Corporation

(21) Appl. No.: 11/095,079

(22) Filed: Mar. 31, 2005

(51) Int. Cl. H04N 1/04

(52) U.S. Cl. 358/474; 358/498

(57) ABSTRACT

A media drive and imaging apparatus such as a document scanner is provided. The apparatus is provided with a rotatable, tubular platen which incorporates one or more light exposure sources or illuminators, and an raster input bar assembly, optionally one or more sensors, and other imaging components and structures inside the tube. The document scanner is also equipped with a pinch roller mechanism which forms a nip with the outside of the tubular platen to pull a document through the apparatus during operation as the document is scanned.

### BACKGROUND

All references cited in this specification, and their references, are incorporated by reference herein where appropriate for teachings of additional or alternative details, features and/or technical background.

Disclosed is a document drive or media drive system for an image reading apparatus such as a document scanning apparatus comprising an integrated imaging system such as an image sensor device, fixed inside the lumen (that is the cavity) of a rotatable platen, and a pinch or backer roller configured to operatively engage the platen to cause a document to be pulled through the image reading apparatus. In particular, the rotatable platen comprises a cylindrical or tubular structure which serves as part of the document drive mechanism of the apparatus and rotates independently of the imaging system. More particularly, the cylindrical or tubular platen comprises a near light-transmissive quality clear plastic such as polycarbonates including cast Lexan®, which also protects the imaging mechanism from deterioration from dirt and debris.

Document scanners or image reading apparatuses, such as that described in U.S. Pat. No. 4,536,077, generally consist of a document supply tray, one or more scanning stations; a mechanism for forming a path for conveying a document removed from the tray past the scanning stations; a document transport mechanism for transporting the document from the supply tray through the scanning stations and back to the tray; an illuminating mechanism, at least one scanning array and an optical system for selectively transmitting images of the document portion viewed through the scanning arrays.

U.S. Pat. No. 5,526,141, for example, describes an original image reading device which includes a first supporting device having a platen roller provided on a side of an original opposed to an image reading device, for conveying the original at a position deviated from an original reading position, and a non-cylindrical original contact device for urging the original toward the image reading device. U.S. Pat. No. 5,526,141 also discloses that the image reading device also has a second supporting device which has a contact-type reading sensor and it is combined with the first supporting device at a fulcrum at an original exit side so as to relatively rotate. The patent also discloses that the original platen roller is separated from the second supporting device upon relative rotation of the first and second supporting devices.

U.S. Pat. No. 5,676,368 discloses a document drive apparatus for directing a document around a corner. The document drive has a drivable drum with a central axis and is rotatably mounted on a mounting surface of a base member in the form of a base plate.

U.S. Pat. No. 5,982,512 discloses a document feeder for a facsimile machine which includes a reading roller for a document reading unit, a shaft about which the roller rotates, a hollow rubber roller through which the shaft is located, an elastic rubber cylinder of a predetermined length mounted inside the rubber tube at the center, and a pair of levers each having a bushing to support the shaft an eccentric cam inserted into each hole of the frames to separate the reading roller from the document reading section thereby connecting the reading rollers to the frames. The document feeder also has brackets attached to both ends of the document reading section to connect the document reading section to the frames.

U.S. Pat. No. 6,771,917 discloses an image forming apparatus consisting of a body having a document table portion on which a document is placed, a scanning unit inside the apparatus body to optically scan an image of the document place on the document table portion, an image forming unit for forming a developer image on a photosensitive drum in accordance with the image information scanned by the scanning unit, a transfer charger for transferring the developer image formed by the developer image unit on a sheet, a fixing unit for fixing the developer image transferred by the transfer charger on the sheet, an ejecting roller for ejecting the sheet on which the developer image is fixed, a sheet receiving unit and a blowing unit for blowing cool air to the sheet receiving unit.

Driving circuits and functional representation of the image bars, for example, are described in U.S. Pat. No. 5,260,718.

Conventional media drive systems are complicated to operate and have limited motion quality performance and reliability. They are also expensive to manufacture. Accordingly, there is a need to produce media drive systems and scanning devices for copiers and printers and scanners which are more compact and with cheaper, smaller and reliable equipment for high quality copying, scanning and printing apparatuses.

### SUMMARY

Aspects disclosed herein include

a document scanning apparatus comprising a cylindrical, movable or rotatable platen having a lumen, and optionally one or more sensors; the platen housing one or more light exposure sources, a lens, and an integrated imaging bar assembly in the lumen, and being operatively coupled to a motor and independently rotatable; and

a media drive and imaging apparatus comprising a pinch or backer roller configured to operatively engage a tubular, rotatable platen to cause a document to be pulled through an image reading device; wherein the tubular, rotatable platen comprises an light-transmissive quality or near light-transmissive quality, durable plastic tube with an illumination system and an imaging system located inside said tube and mounted on support structures.

### BRIEF DESCRIPTION OF DRAWINGS

FIG. 1 is a drawing illustrating a portion of a document drive of a document scanner apparatus comprising a rotatable cylindrical platen and a pinch roller device.

FIG. 2 is a schematic drawing illustrating a side view of the contents of a rotatable, cylindrical platen at one end of the cylinder of a document drive of a document scanner.

FIG. 3 is a schematic drawing illustrating a side view of a document with the rotatable, cylindrical platen partially removed to uncover the interior contents of the rotatable cylinder.

### DETAILED DESCRIPTION

In embodiments there is illustrated:

A document scanner or image reading apparatus is provided with a document drive and imaging assembly integrated within a simple and compact structure. In one embodiment, the document scanner comprises illuminators and scanning equipment such as video boards and the like which are stored or protected within a tube which is used as the platen for moving a document.

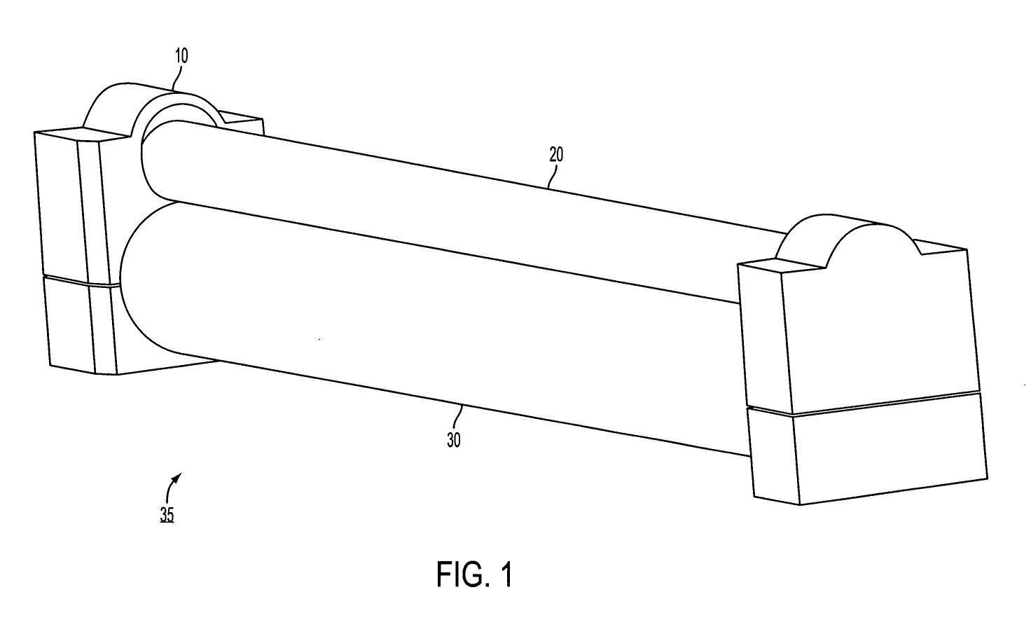

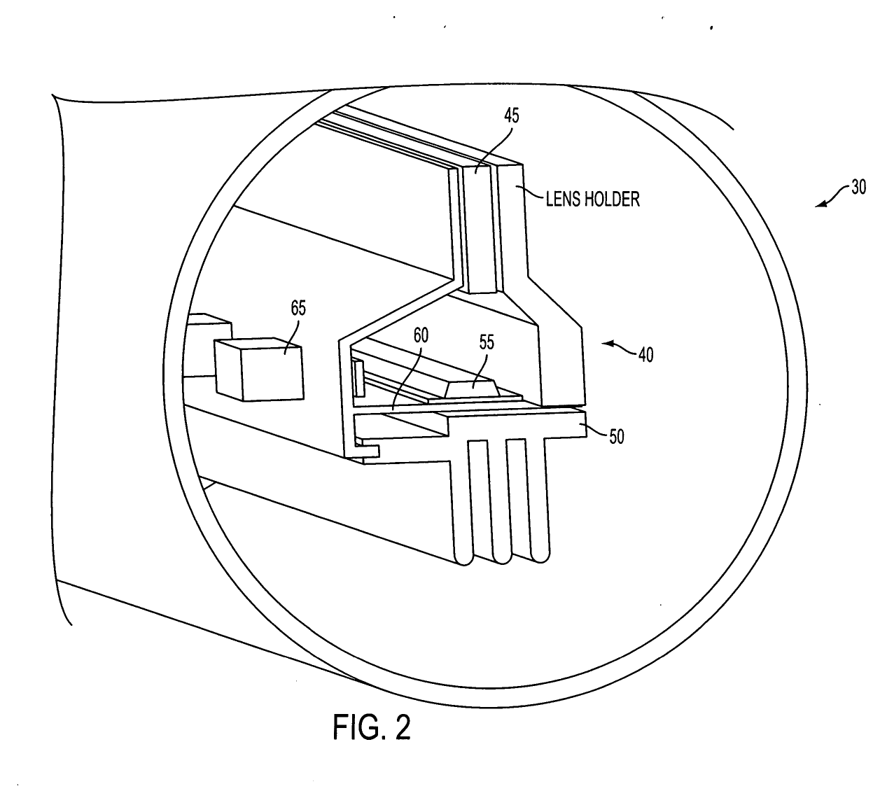

FIG. 1 illustrates an embodiment wherein the document drive and imaging assembly 35 comprise a cylindrical, movable or rotatable platen 30; the platen being operationally coupled to a motor and is independently movable. In the embodiment illustrated in FIG. 1, the document scanner further comprises support structures 10 and a backer or pinch roller device 20 which forms a nip with the outer surface of the movable platen 30 that can pull a document through the apparatus during operation. In this embodiment, during operation, the movable platen causes movement of the pinch roller 20 when a document is being fed through the document drive. In this embodiment, the platen 30 is a hollow tubular structure as illustrated in FIG. 2, which houses a raster input bar (RIB) within the space in the tube. The raster input bar may include at least one linear array of photosensors extending along the length of the cylindrical platen. Platen 30 has two openings at each end and can be made of, for example, durable transparent materials of light-transmissive quality or near light-transmissive quality materials such as thermoplastic polymers, for example, polycarbonates, including LEXAN® (GE Plastics) and the like. The platen 30 can be of differing diameters depending on the system, for example, the outer diameter of the tube can be of from about 40 mm to about 400 mm, or from about 60 to about 200 mm. The platen 30 can also be of varying tube wall thickness, for example, of from about 2 mm to about 10 mm, and can have a length of from about 200 mm to about 2000 mm depending on the apparatus being made. In one embodiment, for example, the platen 30 has an outer diameter of 102 mm, a thickness of 4 mm and 970 mm long.

As illustrated in FIG. 2, the tubular platen 30 integrally houses a raster input bar assembly 40 in its lumen which is fixed to comprising a lens 45, a structure configured to hold the lens or lens holder, image receiver chips 55, connectors 65, a structured configured to absorb heat or “heat sink” device 50 structurally configured to contact and support the lens 45, the lens holder, image receiver chips 55 and a printed wire board assembly 60.

The document scanner apparatus further comprises one or more light exposure or illumination sources such as mercury lamps, fluorescent lamps, light emitting diode (LED) arrays or a reflector, which are housed in the lumen (that is, the cavity) of the platen tube 30. The image reading apparatus can optionally comprise one or more sensors, such as encoders, which can be attached to the tube and can provide auto-timing. In this embodiment, light exposure sources, lens, and an integrated scanning raster input bar assembly, comprising, for example, a light emitting diode, are in a fixed position inside the movable platen and are structurally configured at its end to operatively engaged with the support structure 10 and be structurally adapted to be shielded from dirt. The raster image assembly 40 remains fixed in its support during operation or rotation of the platen 30.

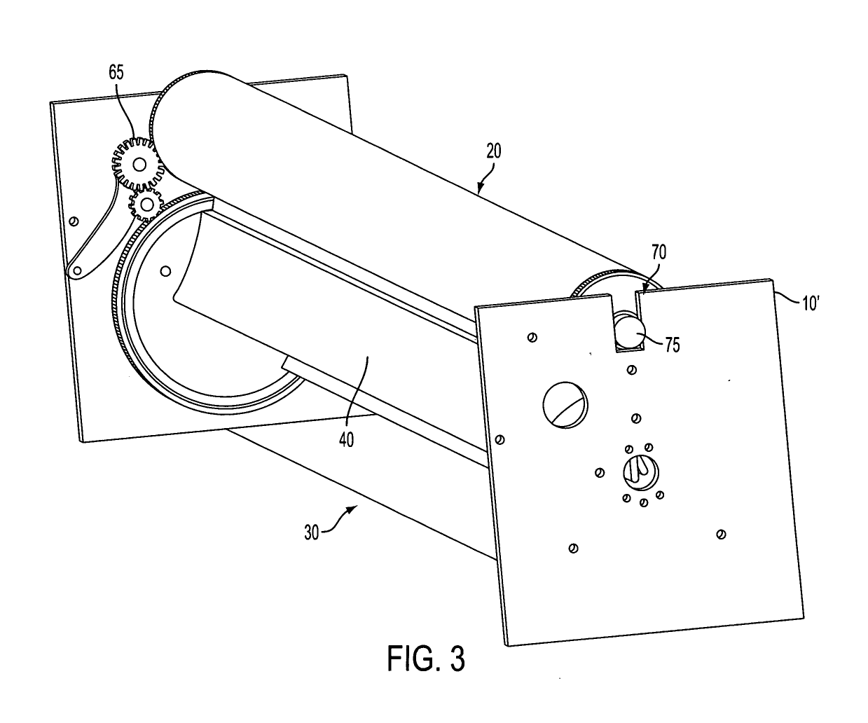

FIG. 3 illustrates the embodiment of FIGS. 1 and 2, in which the platen 30 is partially removed to uncover the raster image bar 40 inside platen 30 and the drive mechanism 65 illustrated herewith as a geared mechanism is operatively configured to engage with the platen 30 to cause rotation of the platen 30 during operation. The geared mechanism 65 is operatively configured to engage to a motor during operation and is secured to one of the support structures 10 and coupled to a gear rim on the edge of the opening of the platen 30 to which it is coupled. The geared mechanism 65 is also operatively configured to support and rotate the backer or pinch roller 20. The pinch roller 20 is provided with a gear rim and an axle or shaft 75 for operatively engaging to the drive mechanism 65. The media drive mounting and support mechanism 10 is structurally configured at one end with a notch 70 which operatively couples to an end axle or shaft 75 of the pinch roller 20. The support structures 10 are also structurally configured to have openings at which may be at a central location of the structure to secure the contents of the structures within the platen 30, such as the raster image bar assembly including, lens, lens support adaptors, image receiver chips, and the like.

In certain embodiments, the lens system of the imaging bar can comprise, for example, mirrors, imaging sensors, and full width array lenses such as a lens with, for example, from about 3 to about 5 arrays, which may be combined with a raster input bar or a raster output bar. A heat sink or heat absorbable structure 50 is provided, which is made of a material capable of absorbing or dissipating heat generated from the raster input bar or raster output bar electronic circuitry which drive photosensors and light emitting devices, such as materials comprising high thermal conductivity including, aluminum, and ceramic material. Heat sinks 50 can be structurally configured in any shape that will accommodate efficient heat removal from the imaging bars. In one embodiment, the media drive and scanning apparatus may comprise a heat shield operatively configured to minimize heat transfer from the imaging system components, for example, a heat shield may comprise structures made of, for example, stainless steel, which can be integrated in close relationship with a heat sink 50 in an imaging bar assembly to control heat in the apparatus.

In one embodiment, addressable image bars can be an imaging device in an electrophotographic printing machines, which are for example, linear substrates having an effective length equivalent to the width of the paper used, for example, letter size or A4 paper. In one embodiment, the raster image bar assembly 40 comprises any suitable image bar, for example, liquid crystal type image bars such as LED image bars addressed by appropriate control systems. The bar may be a write bar with an array of light sources without photosensors to create an image, as well as a bar to record an image. An exemplary image bar assembly used in electrophotographic copier/printer combination is described in U.S. Pat. No. 5,260,718, which disclosure is herein incorporated by reference in its entirety.

The media drive and imaging apparatus also comprises associated driving circuits. Exemplary circuits and image bars are disclosed in U.S. Pat. No. 5,260,718, which disclosure is incorporated herein by reference in its entirety. In embodiments illustrated herein the media drive and imaging apparatus is operatively configured to adapt to an power supply for providing the electricity to energize the system.

While the invention has been particularly shown and described with reference to a particular embodiment, it will be appreciated that variations of the above-disclosed embodiments and other features and functions, or alternatives thereof, may be desirably combined into many other different devices or applications. Also that various presently unforeseen or unanticipated alternatives, modifications, variations or improvements therein may be subsequently made by those skilled in the art which are also intended to be encompassed by the following claims.

What is claimed is:

1. A imaging apparatus comprising: a cylindrical platen, the platen having a least a light-transmissive portion, and defining an inside; and a photosensor disposed in the inside of the cylindrical platen, the photosensor operationally configured to receive light through the cylindrical platen.

2. An imaging apparatus in accordance with claim 1, wherein the apparatus further comprises one or more light exposure sources.

3. An imaging apparatus in accordance with claim 1, wherein the apparatus further comprises a lens.

4. An imaging apparatus in accordance with claim 1, wherein the apparatus further comprises an integrated imaging bar assembly in said inside of said cylindrical platen.

5. An imaging apparatus in accordance with claim 1, wherein the apparatus further comprises a motor operationally coupled to said cylindrical platen to rotate said platen.

6. An imaging apparatus in accordance with claim 1, wherein the cylindrical platen is operatively coupled to a pinch roller to form a nip with said cylindrical platen.

7. An imaging apparatus in accordance with claim 1, wherein the cylindrical platen is a rotatable clear plastic tube of near light-transmissive quality or light-transmissive quality.

8. An imaging apparatus in accordance with claim 1, further comprising an encoder.

9. An imaging apparatus in accordance with claim 4, wherein said integrated imaging bar assembly comprises a light emitting diode raster input bar.

10. An imaging apparatus in accordance with claim 4, integrated imaging bar assembly comprises a lens, a lens support structure, image receiver chips, a printed circuit board assembly, a heat absorbable structure, and connectors.

11. An imaging apparatus in accordance with claim 6 wherein said pinch roller comprises a geared rim mechanism at one end and an axle or shaft; said geared rim operatively configured to adapt to a drive mechanism.

12. An imaging apparatus in accordance with claim 1 wherein the cylindrical platen is a transparent polymer plastic tube having an outer diameter of from about 40 mm to about 400 mm, a wall thickness of from about 2 mm to about 10 mm, and a length of from about 200 mm to about 2000 mm.

13. An imaging apparatus in accordance with claim 2, wherein said one or more light exposure sources is selected from the group consisting of mercury lamps, fluorescent lamps, light emitting diodes and reflectors.

14. A xerographic system comprising an imaging apparatus in accordance with claim 1.

15. A media drive and imaging apparatus comprising a pinch or backer roller configured to operatively engage a tubular, rotatable platen in a manner so as to be able to rotate when said rotatable platen is rotated; wherein said tubular, rotatable platen comprises an light-transmissive quality or near light-transmissive quality, durable plastic tube defining a void, said void encompassing an illumination system and an image reading system.

16. A media drive and imaging apparatus in accordance with claim 15, wherein said tubular, rotatable platen comprises a plastic tube which has an outer diameter of from about 40 mm to about 400 mm, a wall thickness of from about 2 mm to about 10 mm, and a length of from about 200 mm to about 2000 mm.

17. A media drive and imaging apparatus in accordance with claim 15, wherein said tubular, rotatable platen comprises a transparent polycarbonate.

18. A media drive and imaging apparatus in accordance with claim 15, wherein said illumination system comprises one or more light exposure sources selected from the group consisting of mercury lamps, fluorescent lamps, light emitting diodes and reflectors.

19. A xerographic system comprising a media drive and imaging apparatus of claim 15.

20. A media drive and imaging apparatus in accordance with claim 15, wherein said image reading system comprises a lens, image receiver chips, a printed circuit board assembly; a heat absorbable structure, and connectors.
